(19) United States
(12) Patent Application Publication
(10) Pub. No.: US 2009/0018696 A1
(43) Pub. Date: Jan. 15, 2009

(54) Method and Device for Controlling a Robot

(75) Inventors: Christian Goerick, Seligenstadt (DE); Bram Bolder, Langen (DE); Herbert Janssen, Dreieich (DE); Stephan Kirstein, Muhlheim (DE); Heiko Wersing, Frankfurt (DE); Michael Gienger, Frankfurt (DE); Hisashi Sugiura, Frankfurt (DE); Inna Mikhailova, Darmstadt (DE); Tobias Rodemann, Offenbach (DE)

Correspondence Address: FENWICK & WEST LLP, SILICON VALLEY CENTER, 801 CALIFORNIA STREET, MOUNTAIN VIEW, CA, 94041, US

(73) Assignee: HONDA RESEARCH INSTITUTE EUROPE GMBH, Offenbach/Main (DE)

(21) Appl. No.: 12/168,667

(22) Filed: Jul. 7, 2008

(30) Foreign Application Priority Data
Jul. 13, 2007 (EP) 07112444

(51) Int. Cl. G05B 19/04

(52) U.S. Cl. 700/245; 901/1; 901/49

(57) ABSTRACT

A robot controller including a multitude of simultaneously functioning robot controller units. Each robot controller unit is adapted to receive an input signal, receive top-down information, execute an internal process or dynamics, store at least one representation, send top-down information, issue motor commands wherein each motor command has a priority. The robot controller selects one or several motor commands issued by one or several units based on their priority. Each robot controller unit may read representations stored in other robot controller units.

### FIELD OF INVENTION

The present invention is related to a method and a device for controlling a robot, more specifically to a novel architecture for controlling a robot.

### BACKGROUND OF THE INVENTION

A long-standing goal for robot designers has been to produce a robot that acts or behaves “autonomously” and “intelligently” based on its sensory inputs similar to human behavior. One approach for building control systems for such a robot is to provide a series of functional units such as perception, modelling, planning, task execution and motor control that map sensory inputs to actuator commands.

An alternative approach to designing a robot controller was disclosed in R. Brooks, “A robust layered control system for a mobile robot”, IEEE Journal of Robotics and Automation, vol. 2, issue 1, pp. 14-23 (1986). Specifically, R. Brooks discloses using so-called task achieving behaviors as the primary decomposition of the system. Layers or units of control are constructed to allow the robot to operate at increasing levels of competence, comprising asynchronous modules that communicate over low bandwidth channels. Each module is an instance of a simple computational machine. Higher-level layers or units can subsume the roles of lower levels by suppressing the outputs. Lower levels or units continue to function as higher levels are added. In other words, inputs to modules can be suppressed and outputs can be inhibited by wires terminating from other modules. This is the mechanism by which higher-level layers subsume the role of lower levels. Apart from this rudimentary interaction, all layers or units of control are completely separated from each other. In particular, one layer or unit of control may strictly be isolated from the internal states of other layers/units. That is, all layers/units follow separate concerns or tasks.

However, such isolation means that for partially overlapping tasks (that is, tasks having a common sub task), the sub task must be duplicated and may not be shared, leading to an increased use of computational resources.

### SUMMARY OF THE INVENTION

It is an object of the present invention to provide an improved method and device for controlling a robot, in particular, to provide a method and a device that enables sharing of resources among different layers/units.

Embodiments provide a robot controller that allows new functionality to be added to the robot in an incremental manner. This means that a system including the robot controller may act at any time, although the level of performance may vary from version to version.

In one embodiment, the system is compositional in the sense that it comprises parts that may be combined to yield a new quality of behavior. That is, this embodiment is useful for providing system decomposition that allows building of an incremental learning system that can always perform action, although there may be differences in the level of performance. Lower level units provide representations and decompositions that are suited to show a certain behavior at level and are further adapted to serve as helping decompositions for higher levels.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE FIGURES

The teachings of the present invention can be readily understood by considering the following detailed description in conjunction with the accompanying drawings.

FIG. 1 is a schematic block diagram illustrating a robot controller, according to an embodiment.

FIG. 2 is a schematic block diagram illustrating a robot controller, according to another embodiment.

### DETAILED DESCRIPTION OF THE INVENTION

A preferred embodiment of the present invention is now described with reference to the figures where like reference numbers indicate identical or functionally similar elements.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

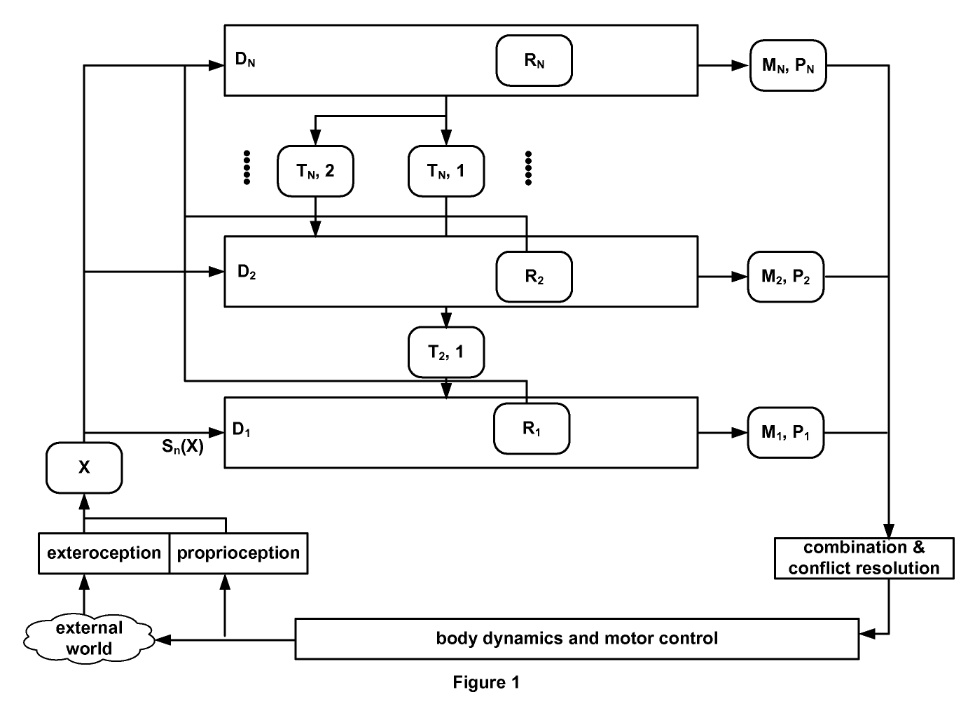

FIG. 1 is a schematic block diagram illustrating a robot controller, according to an embodiment. In general, the generation of autonomous behavior for a humanoid robot according to the embodiment includes receiving sensory inputs and processing the sensory inputs into internal representations that are directly used for generating specific behavior. The processing of sensory information and the generation of behavior may be organized into units. The representations stored in one unit may be provided to other units within the system in order to contribute to the operation or generation of behavior. The units may be arranged into an architecture that generates an overall behavior of the system by controlling access to actuators. In addition to reading the provided representations, a unit may send top-down information to other units.

Specifically, the robot controller according to one embodiment includes multiple robot controller units that function simultaneously. Each unit comprises, among other elements, means for receiving an input signal, means for receiving top-down information (T), means for executing an internal process or dynamics (D), means for storing at least one representation (R) and means for sending top-down information (T).

Each robot controller unit further comprises means for issuing motor commands (M) where each motor command has a priority (P). The robot controller further comprises means for selecting one or more motor commands (M) issued by one or more units based on their priority (P). According to one embodiment, each unit may read representations (R) stored in other units.

More particularly, each identifiable processing unit or loop n may comprise an input space X that is spanned by exteroception (that is, external perception) and proprioception (that is, self perception). Each processing unit or loop n may have an internal process or dynamics Dₙ. Each processing unit or loop may create some system-wide publicly accessible representations Rₙ used by itself and other units within the system. The indices may be extended in order to denote which units are reading from the representation, for example, R_{n,m,o}, . . . . Further, the processing units or loops may process completely independent from all the other units or loops. The unit may use a subspace Sₙ(X) of the complete input space X as well as the representations R₁, . . . , Rₙ₋₁. It can be modulated by top-down information T_{m,n} for m>n. The processing units or loops can send top-down information/modulation T_{n,1} for n>1. The processing units or loops may autonomously send some behavior on the behavior space Bₙ by issuing motor commands Mₙ with weight/priority Pₙ and/or by providing top-down modulation T_{n,1}.

The value of the priority Pₙ need not be coupled to level n as can be seen in the example of underlying stabilizing processes such as balance control. A unit n can always choose to perform solely based on the input space X without other representation m≠n.

The behavioral space covered by the system is a direct product of all Bₙ. The behavior Bₙ may have different semantics Zⱼ depending on the current situation or context Cᵢ. That is, the behavior Bₙ represents skills or actions from the perspective of the systems rather than quantities dependent upon observers.

The motor commands of different units may be compatible or incompatible. In the case of concurrently commanded incompatible motor commands, the conflict may be resolved based on the priorities Pₙ.

All entities describing a unit may be time-dependent. The index n represents a hierarchy with respect to the incremental creation of the system, but other views are also possible. Different views to the system yield different hierarchies defined by the dependency of the representations Rₙ, the priority of the motor commands Pₙ and the time scales of the execution.

In particular, the sensory space Sₙ(X) may be split into several aspects for clearer reference. The aspects concerned with the location of the corresponding entity are indicated as Sₙ^{L}(X), the features are indicated as Sₙ^{F}(X) and the time scale is indicated as Sₙ^{T}(X).

Moreover, the behavior space Bₙ may be split into several aspects for a clearer reference. The aspects concerned with the potential location of the actions are termed Bₙ^{L}, and the qualitative skills are termed Bₙ^{S}. Units may be multi-functional in the sense that the representation Rₙ may be input for more than one other unit, for example, Dₘ: Mₘ=0, Rₘ≠0, D_{n>m}=f(Rₘ, . . . ), D_{1>m}=f(Rₘ, . . . ).

The system may show the following three kinds of plasticity or learning: (i) Learning may take place within a unit n. This may directly influence the representation Rₙ and the behavior space Bₙ. Other units m may be indirectly influenced if units m depend on Rₙ. (ii) Learning may also concern inter-unit relations. This may explicitly be affected by the plasticity of the top-down information T_{n,m} and by changing the way a unit n interprets a representation Rₘ. (iii) Finally, structural learning may be implemented. A new unit may be created or recruited by a developmental process. Deletion may also be possible but not practical as a consequence of multi-functionality. Rather, a higher unit n may take over or completely suppress unit m that would have been removed. This mechanism may be beneficial in the case where unit n becomes corrupted and non-functional. Then unit m may again become functional and keep the system in action. The performance may be lower, but this does not cause complete system failure.

The sensory subspace decomposition Sₙ(X) and behavior space decomposition Bₙ(X): Sₘ(X) for m<n may be subspaces in some feature dimensions for other units generating behavior Bₙ(X) more dimensions may be accessible, that is, higher levels may treat richer information Sₙ(X) concerning the same external physical entity.

All behavior Bₙ may influence the sensory perception Sₘ(X) of other units m. This is also frequently addressed as implicit dependence of units. From this, it follows that Dₘ may depend implicitly on Dₙ for some n. Explicit dependence may be modelled by the representations Rₙ.

Unit n with Dₙ may depend on Rₘ but may simultaneously provide top-down feedback T_{n,m}.

Regarding the relation between a motor command Mₙ, a behavior Bₙ and a context Cᵢ, the motor commands Mₙ are the immediate local descriptions of the actions of the unit n. The behavior Bₙ describes more comprehensive skills or actions from the perspective of the artifact. Unit n may generate behavior not just by sending direct motor commands Mₙ but also by sending top-down information T_{n,m} to other units. The behavior Bₙ may be applicable in more than one context Cᵢ. This means that one behavior Bₙ may have different semantics Zⱼ depending on the context Cᵢ. The unit n may not need to “know” about its own semantics because higher levels know the semantics.

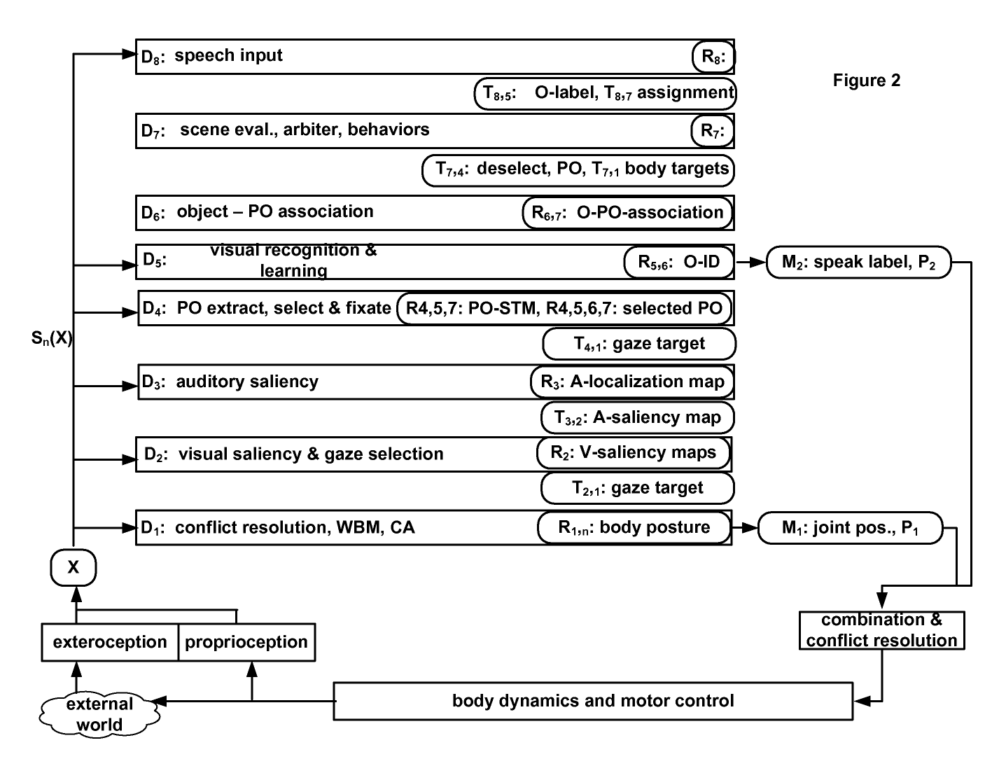

FIG. 2 shows a schematic block diagram of a robot controller according to another embodiment. The elements of the overall architecture are arranged in hierarchical units that produce overall observable behavior.

A first unit D₁ is the whole body motion control of the robot, including conflict resolution for different target commands and self collision avoidance of the robot body.

In one embodiment, the first unit D₁ receives only proprioceptive information about the current robot posture. It also receives top-down information T_{n,1}, in the form of targets for the right and left arm, respectively. In another embodiment, any other unit may provide such kinds of targets.

Without top-down information, the robot stands in a rest position. The behavior subspace B₁ comprises target reaching motions including the whole body while avoiding self collisions.

The semantics Zⱼ that could be attributed to these motions could be “waiting”, “pointing”, “pushing”, “poking” and “walking”, etc. This unit provides motor commands to different joints of the robot.

A second unit D₂ comprises a visual saliency computation based on contrast, peripersonal space and gaze selection. Based on the incoming image S₁(X), visually salient locations in the current field of view are computed and fixated with hysteresis by providing gaze targets or target positions as top-down information T_{2,1} to unit D₁. The sensory space with respect to locations S_{1L}(X) covers the whole possible field of view. Representations R₂ comprise saliency maps, their modulations and corresponding weights. The modulations and the corresponding weights can be set as top-down information T_{n,2}. Depending on this information, different kinds of semantics Zⱼ such as “search”, “explore” and “fixate” could be attributed to behavior space B₂ sent by this unit.

A third unit D₃ computes an auditory localization or saliency map R₃. The localization or saliency map R₃ is provided as top-down information T_{3,2} for unit D₂, where the auditory component is weighted higher than the visual. Behavior space B₃ comprises the fixation of prominent auditory stimuli that may be semantically interpreted as “fixating a person calling the robot.”

A fourth unit D₄ extracts proto-objects from the current visual scene and performs a temporal stabilization in a short term memory (PO-STM). The computation of the proto-objects is purely depth and peripersonal space based. That is, S₄(X) is a sub-part of a depth map. The sensory space with respect to locations S₄L(X) covers only a small portion around the robots body, which is the peripersonal space. The PO-STM and the information about current proto-object selected and fixated form the representation R₄. The top-down information T_{4,2} provided to unit D₂ is gaze targets with a higher priority than the visual gaze selection, yielding the fixation of proto-objects in the current view as behavior B₄. The unit accepts top-down information T_{n,4} for unselecting the currently fixated proto-object or for directly selecting a specific proto-object.

The fifth unit D₅ performs a visual recognition or interactive learning of the currently fixated proto-object. The sensory input space S₅(X) is the current color image and its corresponding depth map. The unit relies on the representation R₄ for extracting the corresponding sub-part of the information out of S₅(X). The representation R₅ provided is the identity O-ID of the currently fixated proto-object. Motor commands M₅ sent by the unit are speech labels or confirmation phrases. The top-down information T_{n,5} accepted by the unit is an identifier or label for the currently fixated proto-object.

A sixth unit D₆ performs an association of the representations R₄ and R₅. That is, the sixth unit D₆ maintains an association R₆ between the PO-STM and the O-IDs based on the identifier of the currently selected PO. This representation can provide the identity of all classified proto-objects in the current view. Other than the representations, the unit D₆ has no other inputs or outputs.

A seventh unit D₇ evaluates the current scene as represented by R₄ and R₆ and sets the targets for the different internal behaviors generating the targets for the hands and walking by sending top-down information T_{7,1} to unit U₁. Additional top-down information T_{7,4} can be sent to the proto-object fixating unit U₄ for unselecting the currently fixated proto-object and for selecting another proto-object. The top-down information T_{n,7} received by this unit is an assignment identifier configuring the internal behavior generation of this unit. The currently implemented behavior space B₇ comprises single or double handed pointing at proto-objects depending on their object identifier, autonomous adjustment of the interaction distance between the robot, and the currently fixated proto-object by walking, returning to the home position and continuous tracking of two proto-objects with both arms while standing. The applicability of the internal behaviors of this unit is determined based on the current scene elements, the current assignment and a mutual exclusion criterion.

The eighth unit D₈ operates on audio streams S₈(X) and processes speech inputs. The results are provided as object labels for the recognizer (T_{8,1}) and as assignments for unit D₇ (T_{8,7}).

The implementation described above shows the following interaction patterns. If the robot is standing without any interaction with a person, the robot looks around and fixates on visually salient stimuli as governed by unit D₂. If a person wants to interact with the robot, he or she can produce some salient auditory stimuli by calling or making some noise. Unit D₃ then generates auditory saliency maps joined with the visual saliency maps. Because the weight of the auditory saliency maps is higher that the visual saliency maps, the auditory saliency maps dominate the behavior of the robot. Nevertheless, both visually salient stimuli and auditory salient stimuli can reinforce each other. The robot looks at the location of the auditory stimulus or the joined saliency maps. This works for all distances from the interacting person to the robot. Units D₂ and D₃ do not command walking to targets. If a person wants to interact closer with the system, he or she would, for example, carry one or more objects into the peripersonal space.

Unit D₄ then extracts proto-object representations for each object and selects one object for fixation. All current proto objects in the current view are tracked and maintained in the PO-STM of unit D₄. The currently selected proto-object is visually inspected by unit D₅, and the proto-object is either learned as a new object or it is recognized as a known object. The corresponding labels or phrases are provided as output of unit D₅.

Unit D₈ provides auditory inputs as top-down information to unit D₅, for example, providing a label for new objects. Unit D₆ provides an association between the proto-objects in PO-STM and their class as provided by unit D₅. Based on this information and a specified task setting, unit D₇ controls the body motions.

The differences between the two major task settings for interaction are pointing to the currently selected proto-object or the pointing to the currently selected and classified proto-object after association in unit D₆. In the first task setting, the robot immediately points at the selected proto-object and constantly attempts to adjust the distance between the selected proto-object and its own body. This provides clear feedback to the interacting person concerning the object the robot is currently paying attention to. In the second task setting, the body motions including pointing and walking is activated if the currently selected proto-object is already classified. That is, there is an association between the currently selected proto-object and an object identifier O-ID in R₆. During such interaction, the robot just looks at the presented object and starts to point at or walk towards the object after successful classification. This task setting is useful if the robot interact only with specific known objects.

In both cases, pointing may be performed with either one hand or two hands depending on objects the robot is fixated upon. Different types of pointing may indicate that the robot knows about the object in addition to its verbally communication. For example, the robot may point at toys with two hands and may point at everything else with one hand.

The overall behavior of the robot corresponds to a joint attention based interaction between a robot and a human where the communication is made by speech, gestures and walking of the robot. The robot also visually learns and recognizes one or more objects presented to the robot as well as act differently when the robot is presented with object which the robot has information about. These are the basic functions necessary for teaching the robot new objects to afford capabilities such as searching a known object in a room. Any unit n may process without higher level units m where m>n. All the representations and control processes established by lower level units may be employed by higher level units for efficient computer resource usage.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A robot controller comprising a plurality of robot controller units, a first robot controller of the plurality of robot controller units adapted to:
receive an input signal;
receive top-down information from one or more robot controller units;
read representations stored in one or robot controller units;
execute an internal process or dynamics based on at least the input signal and a representation stored in the robot controller or the representation read from the one or more robot controller unit;
send top-down information to other robot controller unit based on the stored representation to modulate behavior of another robot controller unit; and
issue a first motor command based on the received top-down information, the first motor command assigned a priority, the first motor command selected by the robot controller for execution based on the priority.

2. The robot controller of claim 1, wherein the first robot controller unit controls a whole body motion of a robot.

3. The robot controller of claim 2, wherein controlling the whole body motion comprises resolving conflicts for multiple target commands.

4. The robot controller of claim 3, wherein controlling the whole body motion further comprises avoiding a self collision of a body of the robot.

5. The robot controller of claim 2, wherein controlling the whole body motion is based on proprioceptive information about a current posture of the robot received by the first robot controller unit.

6. The robot controller of claim 5, wherein the first robot controller unit is further adapted to receive the top-down information representing a first target for a right arm, a second target for a left arm, gaze direction, and a third target for walking.

7. The robot controller of claim 6, further comprising a second robot controller unit adapted to execute a visual saliency computation based on contrast, peripersonal space and gaze selection.

8. The robot controller of claim 7, further comprising a third unit adapted to compute an auditory localization or saliency map.

9. The robot controller of claim 8, further comprising a fourth robot controller unit adapted to extract proto-objects from a current visual scene and perform a temporal stabilization of the proto-objects in a short term memory to form a representation representing the proto-objects.

10. The robot controller of claim 9, further comprising a fifth robot controller unit adapted to perform a visual recognition or interactive learning of a currently fixated proto-object based on a representation of the fourth robot controller unit for extracting corresponding portion of the information.

11. The robot controller of claim 10, further comprising a sixth robot controller unit is adapted to provide an identity of a classified proto-object in a current view.

12. The robot controller of claim 11, further comprising a seventh robot controller unit adapted to set targets for different internal behaviors generating targets for hands of the robot and a body of the robot by sending top-down information to the first robot controller unit.

13. The robot controller of claim 12, wherein the first robot controller unit is adapted to send top-down information to the fourth robot controller unit for unselecting the currently fixated proto-object and selecting another proto-object.

14. A computer readable storage medium structured to store instructions executable by a processor in a computing device in a robot controller, the instructions, when executed cause the processor to:
receive an input signal;
receive top-down information from another robot controller unit in the robot controller;
read representations stored in other robot controller units in the robot controller;
execute an internal process or dynamics based on at least the input signal and a representation stored in the first robot controller or the representation read from the other robot controller units;
send top-down information to a robot controller unit based on the stored representation to modulate behavior of another robot controller unit in the robot controller; and
issue a first motor command based on the received top-down information, the first motor command assigned a priority, the first motor command selected by the robot controller for execution based on the priority.

15. The computer readable storage medium of claim 14, wherein the robot controller unit controls a whole body motion of a robot.

16. The computer readable storage medium of claim 15, wherein controlling the whole body motion comprises resolving conflicts for different target commands.

17. The computer readable storage medium of claim 15, wherein controlling the whole body motion further comprises avoiding a self collision of a body of the robot.

18. The computer readable storage medium of claim 15, wherein controlling the whole body motion is based on proprioceptive information about a current posture of the robot received by the first robot controller unit.

19. The robot controller of claim 18, wherein the robot controller unit is further adapted to receive the top-down information representing a first target for a right arm, a second target for a left arm, gaze direction, and a third target for walking.

20. A method of controlling a robot using a first robot controller unit, comprising:
receiving an input signal;
receiving top-down information from another robot controller unit in the robot controller;
reading representations stored in other robot controller units in the robot controller;
executing an internal process or dynamics based on at least the input signal and a representation stored in the first robot controller or the representation read from the other robot controller units;
sending top-down information to a robot controller unit based on the stored representation to modulate behavior of another robot controller unit; and
issuing a first motor command based on the received top-down information, the first motor command assigned a priority, the first motor command selected by the robot controller for execution based on the priority.

21. A robot controller comprising a plurality of robot controller units, a first robot controller of the plurality of robot controller units comprising:
means for receiving an input signal;
means for receiving top-down information from another robot controller unit;
means for reading representations stored in another robot controller unit;
means for executing an internal process or dynamics based on at least the input signal and a representation stored in the robot controller or the representation read from the other robot controller unit;
means for sending top-down information to other robot controller unit based on the stored representation to modulate behavior of another robot controller unit; and
means for issuing a first motor command based on the received top-down information, the first motor command assigned a priority, the first motor command selected by the robot controller for execution based on the priority.
